(19) United States
(12) Patent Application Publication
(10) Pub. No.: US 2025/0238638 A1
(43) Pub. Date: Jul. 24, 2025

(54) SYSTEM AND METHOD FOR MODIFYING PROMPTS USING A GENERATIVE LANGUAGE MODEL

(71) Applicant: Shopify Inc., Ottawa (CA)

(72) Inventor: Chuanye Ouyang, Gaithersburg, MD (US)

(21) Appl. No.: 18/418,740

(22) Filed: Jan. 22, 2024

(51) Int. Cl. G06F 40/58; G06F 40/284; G06F 40/51

(52) U.S. Cl. CPC G06F 40/58; G06F 40/284; G06F 40/51

(57) ABSTRACT

Outputs generated by an LLM may depend significantly on the precise language of instructions and context included in a prompt into the LLM. However, can be difficult for users to define the exact language of instructions and context to be included in the prompt to generate desirable outputs. A computer-implemented method may involve: obtaining a candidate prompt including input data and instructions; inputting the candidate prompt into a LLM and receiving at least one candidate output generated by the LLM; receiving user input directed to the candidate prompt and/or the at least one candidate output; inputting at least the user input and one or both of the candidate prompt and the candidate output into the LLM as a modification prompt and receiving a subsequent candidate prompt generated by the LLM. The subsequent candidate prompt may include modified candidate instructions different from the candidate instructions.

### BACKGROUND

Generative language models may be large neural network predictive models which determine probabilities for a next word conditional on previous or historical words. Large language models (LLMs) are an example of a generative language model. LLMs may be responsive to prompts including one or more of instructions, context and input data.

### SUMMARY

As used herein, a prompt into a generative language model (e.g., an LLM) includes at least instructions (e.g., describing a processing task to be performed by the LLM on input data), context (e.g., output examples, features associated with a desirable output, additional contextual information related to the input data) and input data (e.g., input data be processed by the LLM using the instructions). In response to the prompt, the LLM may generate an output. For example, a particular prompt into a LLM may include instructions of “translate into French”, context of “input data is related to a shoe product review” and input data of “I found the shoes to be comfortable and supportive”. In this case, the processing task performed by the LLM is an English to French translation processing task. The LLM may generate an output of “J'ai trouvé les chaussures confortables et offrant un bon maintien” in response to the particular prompt.

For a particular processing task performed on input data, an LLM may perform the processing task differently and generate a wide variety of different outputs depending significantly on the specific language of the instructions defining the processing task and specific language of the context. The language of the instructions and the context are often initially defined by a human user (e.g., prompt engineers). However, it can be difficult for such users to define the exact language of the instructions and the context which should be used to generate desirable outputs. It can even be difficult for such users to pre-define what would be a desirable output generated by the LLM, particularly at the beginning of a particular processing task. Further, it is often necessary for such users to engineer a prompt for a particular processing task multiple times and in an iterative manner. It can be difficult to keep track of previous iterations and assess whether continued prompt modifications are desirable. Additionally, one LLM may perform the particular processing task on the particular input data differently to generate different outputs when compared to another LLM even when the prompt into both LLMs include the same language. Such differences may stem from the training data used to train different LLMs or underlying model architecture of different elements. It may thus also be difficult for a user to utilize similar strategies to engineer prompts for different LLMs.

As a possible solution to the above issues, a particular LLM may be used to generate further candidate prompts based on user input directed to a previous prompt and/or previous outputs generated by the same LLM (e.g., based on that previous prompt). This can allow both candidate prompts and candidate outputs to be generated by the same LLM, removing the onus on users to independently develop the language of prompts. This can also improve the efficiency of using a particular LLM in performing a processing task, as the LLM can itself be used iteratively to refine and improve language of a prompt to be inputted into the LLM for that processing task based on the user input. In some embodiments, a first LLM may be used to perform the processing task and a second LLM may be used to generate further candidate prompts for the processing task performed by the first LLM. Such embodiments may be utilized when the first LLM is more adapted to the processing task but the second LLM is more adapted to the prompt modification task.

A user interface (UI) can be used to display a current task prompt into the LLM and a current output generated by the LLM (e.g., based on the current task prompt) and to receive the user input directed to the current task prompt or the current output, which can in turn facilitate efficient interactions between the user and the LLM(s). The UI may include a candidate template configured to display different candidate task prompts and different candidate outputs, and to receive user input on the different candidate task prompts and/or different candidate outputs, which can also allow efficient iterative generation of both candidate task prompts and candidate outputs by the LLM(s). The UI may also include a progress display which can provide a backtracking mechanism to re-evaluate previous iterations of candidate task prompts, candidate outputs and/or the user inputs.

According to one embodiment, a computer-implemented method is provided. The computer-implemented method may include: obtaining a candidate prompt including input data and candidate instructions for processing the input data; inputting at least the candidate prompt into a generative language model; receiving, from the generative language model and responsive to input of at least the candidate prompt, at least one candidate output generated by the generative language model; outputting the candidate prompt and the at least one candidate output; receiving user input directed to one or both of the candidate prompt and the at least one candidate output; inputting at least the user input and one or both of the candidate prompt and the at least one candidate output into the generative language model; and receiving, from the generative language model and responsive to input of at least the user input and one or both of the candidate prompt and the at least one candidate output, a subsequent candidate prompt generated by the generative language model. The subsequent candidate prompt may include modified candidate instructions for processing the input data which are different from the candidate instructions.

In some embodiments, the user input may include a score of one or both of the candidate prompt and the at least one candidate output. The inputting the user input into the generative language model may include inputting the score into the generative language model.

In some embodiments, the user input may further include at least one of a comment associated with one or both of the candidate prompt and the at least one candidate output; or a flag associated with one or both of the candidate prompt and the at least one candidate output. Inputting the user input into the generative language model may include inputting at least one of the comment or the flag into the generative language model.

In some embodiments, the computer-implemented method may further include: inputting at least the subsequent candidate prompt back into the generative language model; and receiving, from the generative language model and responsive to input of the subsequent candidate prompt, at least one subsequent candidate output generated by the generative language model.

In some embodiments, the computer-implemented method may further include: receiving subsequent user input directed to one or both of the subsequent candidate prompt and the at least one subsequent candidate output; inputting the subsequent user input and one or both of the subsequent candidate prompt and the at least one subsequent candidate output into the generative language model; and receiving, from the generative language model and responsive to input of at least the subsequent user input and one or both of the subsequent candidate prompt and the at least one subsequent candidate output, a further subsequent candidate prompt generated by the generative language model. The further subsequent candidate prompt may include further modified candidate instructions for processing the input data which is different from the modified candidate instructions.

In some embodiments, the computer-implemented method may further include reverting back to inputting the candidate prompt into the generative language model yielding the at least one candidate output responsive to receiving the at least one subsequent candidate output.

In some embodiments, the computer-implemented method may further include iteratively inputting successive candidate prompts generated by the generative language model back into the generative language model yielding corresponding successive at least one candidate outputs.

In some embodiments, the computer-implemented method may further include: iteratively receiving user input directed to one or more of the successive candidate prompts and the corresponding successive at least one candidate outputs; and iteratively inputting the user input and one or more of the successive candidate prompts and the corresponding successive at least one candidate outputs back into the generative language model to generate further candidate prompts.

In some embodiments, the computer-implemented method may further include a candidate template for iteratively receiving different candidate prompts including at least one of different candidate instructions or different input data. Obtaining the candidate prompt, inputting at least the candidate prompt into the generative language model and receiving the at least one candidate output may include: iteratively inputting the candidate template including the different candidate prompts into the generative language model; and iteratively receiving, from the generative language model and responsive to the inputting of the candidate template, corresponding different at least one candidate outputs generated by the generative language model.

In some embodiments, the candidate template may include: a prompt region for inputting the different candidate prompts, the prompt region including an instructions subregion for inputting the different candidate instructions and an input data subregion for inputting the different input data; and an output region for displaying the corresponding different at least one candidate outputs.

In some embodiments, outputting the candidate prompt and the at least one candidate output may include outputting for display, on a display of a user device, the candidate prompt and the at least one candidate output.

In some embodiments, the computer-implemented method may further include storing a plurality of nodes, each node comprising a prompt and at least one output generated by the generative language model based on the prompt. A first node and a second node of the plurality of nodes may be connected by an edge when the first node includes a first prompt and at least one first output and the second node includes a second prompt generated by the generative language model utilizing user input directed to one or both of the first prompt and the at least one first output.

In some embodiments, the computer-implemented method may further include outputting for display, on a display of a user device, a progress region including the plurality of nodes and edges between nodes of the plurality of nodes.

In some embodiments, the computer-implemented method may further include automatically outputting a particular prompt associated with a particular node and at least one particular output associated with the particular node in response to user selection of the particular node.

In some embodiments, the at least one candidate output may include a plurality of candidate outputs and receiving the user input may include receiving user input directed to different candidate outputs of the plurality of candidate outputs.

According to another embodiment, a system is provided. The system may include at least one processor and a memory storing processor-executable instructions that, when executed, cause the at least one processor to: input at least a candidate prompt including input data and candidate instructions for processing the input data into a generative language model; receive, from the generative language model and responsive to input of the candidate prompt, at least one candidate output generated by the generative language model; output the candidate prompt and the at least one candidate output; receive user input directed to one or both of the candidate prompt and the at least one candidate output; input at least the user input and one or both of the candidate prompt and the at least one candidate output into the generative language model; and receive, from the generative language model and responsive to input of at least the user input and one or both of the candidate prompt and the at least one candidate output, a subsequent candidate prompt generated by the generative language model. The subsequent candidate prompt may include modified candidate instructions for processing the input data which are different from the candidate instructions.

In some embodiments, the processor-executable instructions may further include processor-executable instructions which cause the at least one processor to iteratively input successive candidate prompts generated by the generative language model back into the generative language model yielding corresponding successive at least one candidate outputs.

In some embodiments, the processor-executable instructions may further include processor-executable instructions which cause the at least one processor to: iteratively receive user input directed to one or more of the successive candidate prompts and the corresponding successive at least one candidate outputs; and iteratively input the user input and one or more of the successive candidate prompts and the corresponding successive at least one candidate outputs back into the generative language model to generate further candidate prompts.

In some embodiments, the processor-executable instructions may further include processor-executable instructions which cause the at least one processor to store a plurality of nodes, each node comprising a prompt and at least one output generated by the generative language model based on the prompt. A first node and a second node of the plurality of nodes may be connected by an edge when the first node includes a first prompt and at least one first output and the second node includes a second prompt generated by the generative language model utilizing user input directed to one or both of the first prompt and the at least one first output.

According to another embodiment, a non-transitory computer-readable storage medium is provided. The non-transitory computer-readable storage medium may have stored thereon processor-executable instruction that, when executed, cause at least one processor to: obtain a candidate prompt including input data and candidate instructions for processing the input data; input at least the candidate prompt into a generative language model; receive, from the generative language model and responsive to the inputting of at least the candidate prompt, at least one candidate output generated by the generative language model; output the candidate prompt and the at least one candidate output; receive user input directed to one or both of the candidate prompt and the at least one candidate output; input at least the user input and one or both of the candidate prompt and the at least one candidate output into the generative language model; and receive, from the generative language model and responsive to the inputting of at least the user input and one or both of the candidate prompt and the at least one candidate output, a subsequent candidate prompt generated by the generative language model. The subsequent candidate prompt may include modified candidate instructions for processing the input data which are different from the candidate instructions.

Other aspects and features of the present disclosure will become apparent to those ordinarily skilled in the art upon review of the following description of specific embodiments of the disclosure in conjunction with the accompanying figures.

### BRIEF DESCRIPTION OF DRAWINGS

Reference will now be made, by way of example, to the accompanying drawings which show example embodiments of the present application, and in which:

FIG. 1A is a block diagram of a simplified convolutional neural network, which may be used in examples of the present disclosure;

FIG. 1B is a block diagram of a simplified transformer neural network, which may be used in examples of the present disclosure;

FIG. 2 is a block diagram of an example computing system, which may be used to implement examples of the present disclosure;

FIG. 3 is a block diagram of a system in accordance with one embodiment;

FIG. 4 is a schematic of a prompt modification server of the system of FIG. 3 in accordance with one embodiment;

FIG. 5 is a schematic of a candidate template generated by user interface codes executed at the prompt modification server of FIG. 4 in accordance with one embodiment;

FIG. 6 is a schematic of a progress display generated by the user interface codes executed at the prompt modification server of FIG. 4 in accordance with one embodiment;

FIG. 7 is a flowchart of a modify task prompt process executed at the prompt modification server of FIG. 4 in accordance with one embodiment; and

FIG. 8 is a flowchart of a computer-implemented method for using a generative language model to generate candidate task prompts executed at the prompt modification server of FIG. 4 in accordance with one embodiment.

### DETAILED DESCRIPTION

A generative language model, such as an LLM as described below, may receive a task prompt comprising at least instructions and input data. In response to the task prompt, the LLM generates at least one candidate output. For a particular processing task performed on particular input data, the LLM may perform the processing task differently depending significantly on specific language of the instructions defining the processing task and specific language of the context and may generate a wide variety of different outputs. The language of the instructions and the context in a prompt are often initially defined by a human user (e.g., prompt engineers). However, it can be difficult for such users to precisely define the language of instructions and context which could be used to guide the LLM to a desirable output. It can even be difficult for such users to pre-define what would be a desirable output, particularly at the beginning of a particular processing task.

Embodiments herein relate utilizing a generative language model (e.g., an LLM as described below) to generate at least one candidate task prompts to be used by the same generative language model (or a different generative language model) to perform processing tasks and based on user input directed to a previous task prompt and/or previous outputs generated by the same generative language model (or the different generative language model). This can allow both candidate task prompts and candidate outputs to be generated by an LLM (e.g., both by the same LLM or by different LLMs), removing the onus on users to independently develop the language of prompts. In embodiments where the same LLM generates both the candidate task prompts and the candidate outputs, the efficiency of using a particular LLM to perform a processing task may be improved, as the LLM can itself be used iteratively to refine and improve language of a prompt to be inputted into that LLM for that processing task.

Additionally, embodiments herein also relate utilizing a user interface (UI) to display a current task prompt to be inputted into the LLM(s) and a current candidate output generated by the LLM(s) (e.g., based on the current prompt) and facilitate receipt of user input on the current task prompt or the current output. The UI may include a candidate template configured to iteratively display candidate task prompts and resulting candidate outputs, and to receive user input on the candidate task prompts and/or resulting candidate outputs, which can further facilitate efficient interactions between the user and the LLM(s) and efficient iterative generation of both candidate task prompts and candidate outputs by the LLM(s). The UI may also include a progress display which can provide a backtracking mechanism to allow users to re-evaluate and/or re-engineer previous iterations of candidate task prompts, candidate outputs and/or user inputs on the candidate task prompts and/or candidate outputs.

Some general concepts relevant to neural networks and machine learning are initially introduced below, and specifics of the embodiments are described thereafter.

### Neural Networks and Machine Learning

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g., each data entry in the training dataset may be paired with a label), or may be unlabeled.

Training a ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

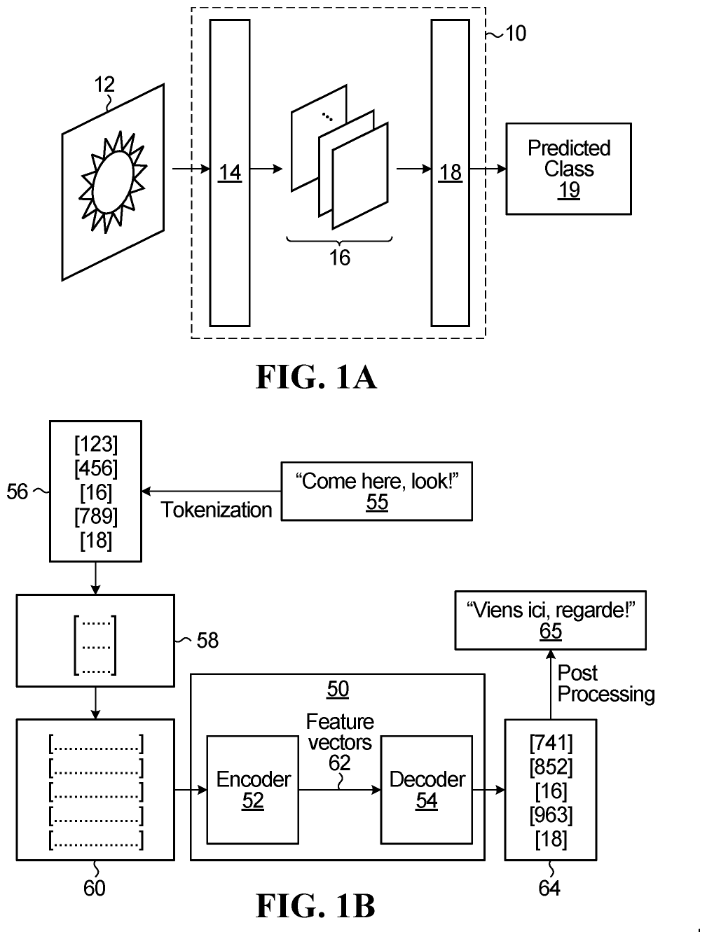

FIG. 1A is a simplified diagram of an example CNN 10, which is an example of a DNN that is commonly used for image processing tasks such as image classification, image analysis, object segmentation, etc. an input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification 19 for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabeled. LLMs may be trained on a large unlabeled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” 55 is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!” 65) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

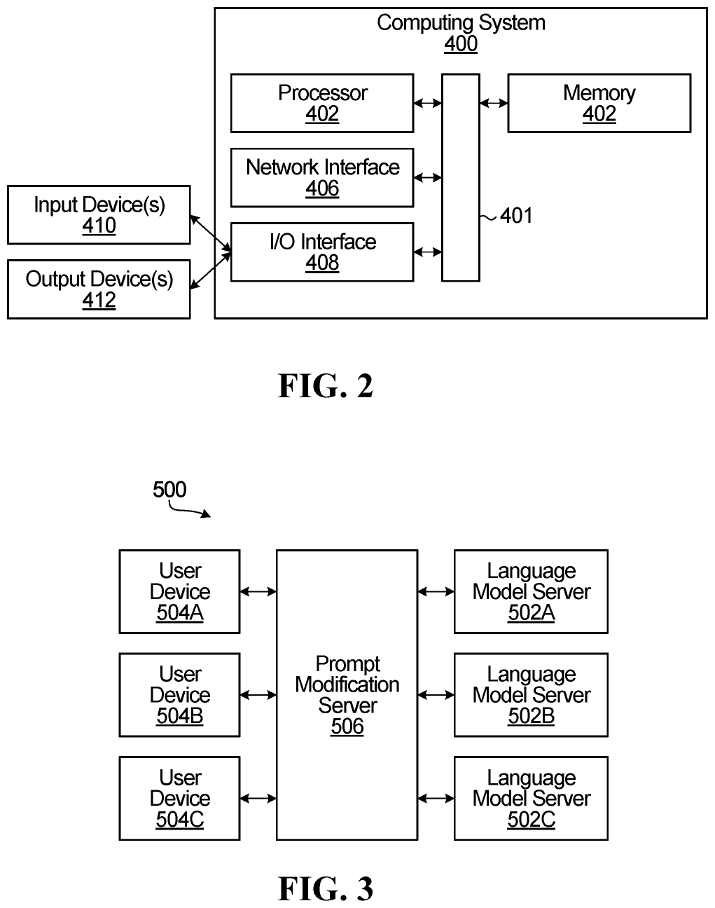

FIG. 2 illustrates an example computing system 400, which may be used to implement examples of the present disclosure, such as a prompt generation engine to generate prompts to be provided as input to a language model such as an LLM. Additionally or alternatively, one or more instances of the example computing system 400 may be employed to execute the LLM. For example, a plurality of instances of the example computing system 400 may cooperate to provide output using an LLM in manners as discussed above.

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a P2P network, a WAN and/or a LAN). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

A computing system, such as the computing system 400 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

### System 500

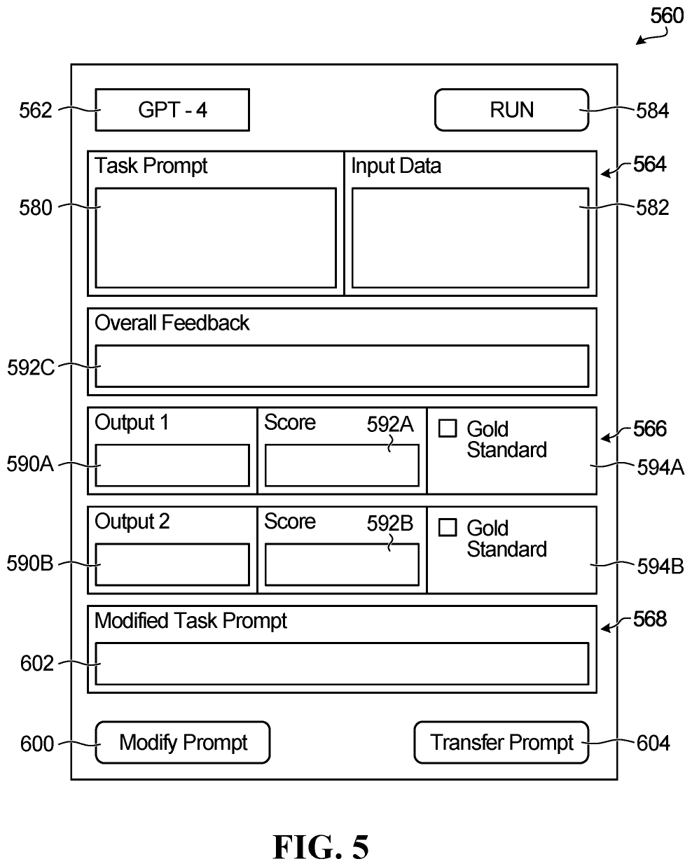

Referring to FIG. 3, a block diagram illustrating a system for utilizing generative language models (e.g., LLM as described above) to refine and improve the language of a prompt to be inputted into the LLM for a particular processing task is shown generally at 500. The system 500 includes a plurality of language model servers 502 (illustrated as 502A-502C in FIG. 3, reference character “502” as used herein may refer to any one language model server of the plurality of language model servers or the plurality of language model servers as a whole), a plurality of user devices 504 (illustrated as 504A-504C in FIG. 5, reference character “504” as used herein may refer to any one user device of the plurality of user devices or the plurality of user devices as a whole), and a prompt modification server 506.

The language model servers 502 may comprise any computer or program that communicates with other computers, programs, or user devices, either in the same computer, over a local network, or over a public network such as the internet. As non-limiting examples, the language model servers 502 may be application, communication, mail, database, proxy, fax, file, media, web, peer-to-peer, standalone, software, or hardware servers (i.e., server computers) and may use any server format known to one of ordinary skill in the art. The language model servers 502 may include corresponding processors for performing the operations of the language model servers 502 (e.g., by executing instructions stored in corresponding program memories of the language model servers 502), corresponding storage memories for hosting or storing a language model, which may be a generative language model such as an LLM as described above, and may specifically be standard off-the-shelf (OTS) LLMs such as GPT-4, GPT-3.5, Claude 2, PaLM 2) for example. The corresponding processors of the language model servers 502 may have increased processing capacity and computing resources for training and/or fine-tuning various language models. The language model servers 502 may further include corresponding network interfaces (e.g., a transmitter/receiver with an antenna or a network interface card or a port) for communicating with the prompt modification server 506 and/or the user devices 504.

In the embodiment shown in FIG. 3, only three language model servers 502A, 502B and 502C are shown; in other embodiments, a greater number or a fewer number of language model servers 502 may be in communication with the prompt modification server 506 and the user devices 504. Each of the language model servers 502A, 502B and 502C may store a different LLM. For example, the language model server 502A may store GPT-4, the language model server 502B may store Claude 2, and the language model server 502C may store PaLM 2. As described above, each of the different LLMs stored by the language model servers 502A, 502B and 502C may have different model architecture (e.g., a transformer model versus a recurrent neural network model, different number of parameters), may be trained on different training data, and may have different context windows. Due to these differences, certain LLMs may be better configured for performing certain processing tasks than other LLMs. For example, GPT-4 may have been trained on a dataset including text in a larger variety of languages than Claude 2 and may thus be better configured for translation processing tasks than Claude 2. As an additional example, PaLM 2 may be more adapted to a translation processing task due its training dataset and underlying transformer model architecture, but GPT-4 may be more adapted to generating text for the prompt modification task due to its underlying recurrent neural network model architecture. Also due to these differences, different LLMs may generate different outputs even when a same candidate task prompt is inputted into the different LLMs.

The user devices 504 may be, for example, a mobile phone, or a tablet, or a laptop, or a personal computer, etc. A client device 504 may include a processor for performing the operations of the client device 504 (e.g., by executing instructions stored in a program memory of the client device 504), a network interface (e.g., a transmitter/receiver with an antenna or a network interface card or a port) for communicating with the prompt modification server 506 and the language model servers 502 and a user interface (e.g., keyboard, display, and/or touchscreen) for displaying content received from the prompt modification server 506 and/or the language model server 502 and for inputting user input directed to one or both of a candidate task prompt inputted into the LLMs hosted/stored by the language model servers 502 and/or at least one candidate output generated by the LLMs in response to the candidate task prompt. In the embodiment shown in FIG. 3, three user devices 504A, 504B and 504C are shown; in other embodiments, a greater number or a fewer number of user devices 504 may be in communication with the language model servers 502 and the prompt modification server 506.

### Prompt Modification Server 506

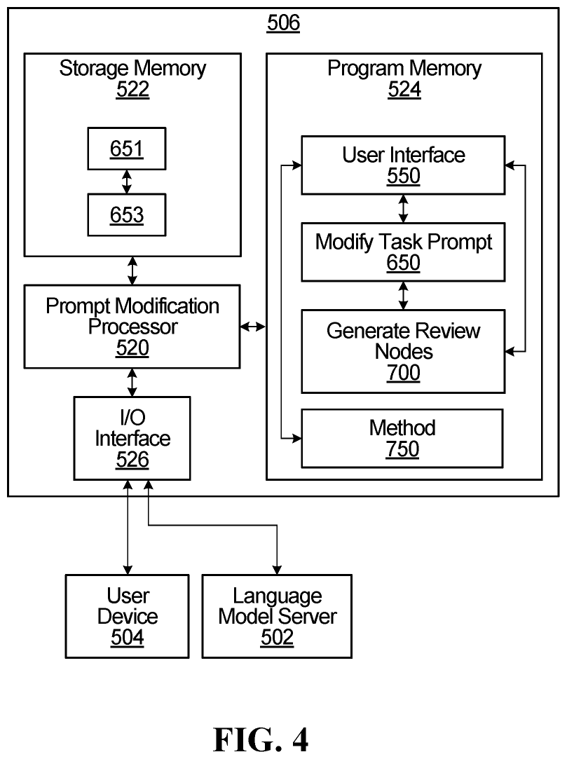

Referring to FIGS. 3 and 4, the prompt modification server 506 in communication with the language model servers 502 and the user devices 504 in accordance with one embodiment is shown. The prompt modification server 506 may be configured to one or more of: (a) input candidate task prompts including instructions, context and input data into the LLMs stored on the language model servers 502 to generate corresponding candidate outputs in response to the candidate the task prompts; (b) input modification prompts including user input directed to one or both of the candidate outputs (generated by the LLMs in response to the candidate task prompts) and the candidate task prompts (inputted into the LLM to generate the corresponding candidate outputs) back into the same LLM (or a different LLM hosted by the language model servers 502) to generate subsequent (modified) candidate task prompts based on the modification prompts; (c) store a candidate task prompt and at least one candidate output generated (by a LLM) based on the candidate task prompt as a node of a plurality of nodes; (d) store a modification prompt and at least one candidate task prompt generated (by a LLM) based on the modification prompt as an edge of a plurality of edges and (e) generate a UI to facilitate interactions between users of the user devices 504 and the LLMs hosted/stored by the language model servers 502. As briefly described above, utilizing LLMs to generate both candidate task prompts and candidate outputs may remove the onus on users to independently develop language of prompts and improve the efficiency of using LLMs to perform a processing task.

In some embodiments, the prompt modification server 506 is similar to the example computing system 400 described above. Another embodiment of the prompt modification server 506 is shown in FIG. 4; in this embodiment shown, the prompt modification server 506 includes at least one prompt modification processor 520, and a storage memory 522, a program memory 524 and an input/output (I/O) interface 576 all in communication with the prompt modification processor 520. Other embodiments of the prompt modification server 506 may include fewer, additional or alternative components. Additionally, although only a single prompt modification processor 520, a single storage memory 522, a single program memory 524, and a single I/O interface 526 is shown in FIG. 4, other embodiments of the prompt modification server 506 may include more than one of each of these components.

The storage memory 522 stores information received or generated by the prompt modification processor 520 and may generally function as an information or datastore. In the embodiment shown, the storage memory 522 includes a node datastore 651 storing the plurality of nodes and an edge datastore 653 storing the plurality of edges; in other embodiments, the storage memory 522 may include fewer, additional or alternative datastores. The program memory 524 stores various blocks of code (alternatively called processor, machine and/or computer executable instructions), including user interface codes 540 for communicating with the user interfaces of the user devices 504 and codes for directing the prompt modification processor 520 to perform various processes, a modify task prompt process 650, a generate nodes process 700 and a method 750 as described below. The program memory 524 may also store database management system codes for managing the datastores in the storage memory 522. In other embodiments, the program memory 524 may store fewer, additional or alternative codes for directing the prompt modification processor 520 to execute additional or alternative functions. The storage memory 522 and the program memory 524 may each be implemented as one or a combination of a non-transitory computer-readable and/or non-transitory machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching thereof). The expression “non-transitory computer-readable medium” or “non-transitory machine-readable medium” as used herein is defined to include any type of computer-readable storage device and/or storage disk and to exclude propagating signals and to exclude transmission media.

The I/O interface 526 comprises an interface for receiving and transmitting information between the prompt modification server 506 and different subsystems within the system 500, including the language model servers 502 and the user devices 504. For example, the prompt modification server 506 may receive the user input transmitted by the user devices 504 and may transmit the candidate task prompts and the modification prompts to the language model servers 502 over a network (such as a wireless network or a wired network, a public network or a private network) via the I/O interface 526. The language model servers 502 may transmit candidate outputs and candidate task prompts generated by the LLMs hosted/stored on the language model servers 502 back to the prompt modification server 506 via the I/O interface 526. The prompt modification server 506 may transmit the candidate outputs and the candidate task prompts to, or for display on, the user devices 504 also via the I/O interface 526. The I/O interface 526 may include any communication interface which enables the prompt modification processor 520 to communicate with external components, including specialized or standard I/O interface technologies such as channel, port-mapped, asynchronous for example. In some embodiments, the I/O interface 526 may be implemented using a network interface card (NIC), a port, and/or a network socket.

The prompt modification processor 520 may be configured to execute codes stored in the program memory 524, to retrieve information from and store information into the datastores of the storage memory 522, and to receive and transmit information to the language model servers 502 and the user devices 504 over the I/O interface 526, examples of which are described below. In the embodiment shown, the prompt modification processor 520 is a server central processing unit and may be a multi-core processor.

### User Interface Codes 550

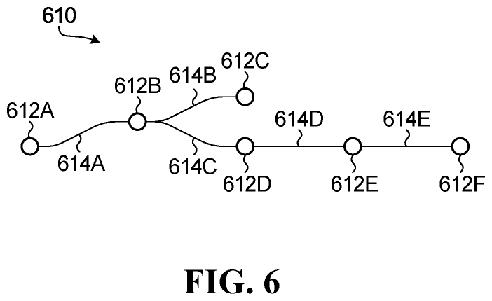

The program memory 524 includes the user interface codes 550 for communicating with the user interfaces of the user devices 504 and for causing information to be displayed on the displays of the user devices 504. For example, the user interface codes 330 may include various codes to enable a user of the user devices 504 to interact with the prompt modification server 506 and/or the language model servers 502 via a software application, a mobile application or a web application. For example, a user of the user devices 504 may access a candidate template 560 (shown in FIG. 5) and a progress display 610 (shown in FIG. 6) generated by the user interface codes 550 of the prompt modification server 506 using a software application installed on the user devices 504 and/or using an internet browser installed on the user device 504.

### Candidate Template 560

The candidate template 560 produced by the user interface codes 550 for display on the displays of the user devices 504 in accordance with one embodiment is illustrated in FIG. 5. Generally, the candidate template 560 enables and facilitates users of the user devices 504 to input a candidate task prompt into LLMs, receive candidate outputs generated by LLMs in response to the candidate task prompt, input user input regarding one or both of the candidate outputs and/or the candidate task prompt which may be included in a modification prompt into the LLMs, and receive subsequent (e.g., modified) candidate task prompts generated by the LLMs in response to the modification prompt, where the subsequent candidate task prompts are different from the candidate task prompt. The subsequent candidate task prompts may then be used as the candidate task prompt for a subsequent iteration of prompt modification (e.g., to generate subsequent candidate outputs and further subsequent candidate task prompts) as described below. Accordingly, the candidate template 560 may facilitate efficient interactions between the user and LLMs stored/hosted by the language model servers 502 for iterative generation of candidate outputs which can be used to generate candidate task prompts, which can then in turn be used to generate subsequent candidate outputs as described below. For example, the candidate template 560 may be used to iteratively receive different candidate task prompts and the prompt modification processor 520 may iteratively input the candidate template 560 including the different candidate task prompts into the LLMs and iteratively receive corresponding different at least one candidate outputs generated by the LLMs.

In the embodiment shown in FIG. 5, the candidate template 560 includes a language model selector 562, a task prompt region 564, candidate output region 566 and a modify prompt region 568. The language model selector 562 may enable selection of a language model of a plurality of different language models into which one or both of the candidate task prompts and the modification prompts may be inputted into to generate, respectively, corresponding candidate outputs and corresponding subsequent candidate task prompts. For example, the language model selector 562 may comprise a drop-down list including the LLMs stored/hosted by different ones of the language model servers 502 in communication with the prompt modification server 506. As a more specific example, in embodiments where the prompt modification server 506 is in communication with the language model server 502A storing/hosting GPT-4, the language model server 502B storing/hosting Claude 2, and the language model server 502C storing/hosting PaLM 2 (shown in FIG. 4), the language model selector 562 may include “GPT-4”, “Claude 2” and “PaLM 2” as selectable options. In the embodiment shown in FIG. 5, the language model selector 562 includes only the single drop-down list including a single LLM into which both the candidate task prompts and the modification prompts may be inputted. As described above, in such embodiments, the same LLM may be used to generate both the candidate outputs and the candidate task prompts as described below. This may improve the efficiency of using a particular LLM in performing a particular processing task, as the LLM can itself be used to iteratively refine and improve the language of task prompts to be inputted into that LLM. Further, utilizing the same LLM to generate both the candidate outputs and the candidate task prompts may facilitate consistency in the outputs and the task prompts generated.

However, in other embodiments, the language model selector 562 may include a first drop-down list including language models into which the candidate task prompts may be inputted and a second drop-down list including language models into which the modification prompts may be inputted. In such embodiments, a first LLM may be selected to process the candidate tasks prompts to generate the candidate outputs and a different second LLM may be selected to process the modification prompts to generate the subsequent candidate task prompts. Such embodiments may be utilized when the first LLM is more adapted to a particular processing task but the second LLM is more adapted to the prompt modification task as described below. For example, PaLM 2 may be more adapted to a translation processing task due to its training dataset and underlying transformer model architecture, but GPT-4 may be more adapted to generating text for the prompt modification task due to its recurrent neural network model architecture. In such embodiments, “PaLM 2” may be selected in the first drop-down list as the LLM into which the candidate task prompts are inputted while “GPT-4” may be selected in the second drop-down list as the LLM into which the modification prompts are inputted.

The task prompt region 564 may generally be configured to iteratively receive different candidate task prompts including at least one of different instructions, different context and/or different input data. In the embodiment shown in FIG. 5, the task prompt region 564 comprises an instructions subregion 580, an input data subregion 582 and a task prompt input button 584. The instructions subregion 580 may be configured to receive user input defining candidate test prompts (originating from a particular one of the user devices 504) and/or LLM generated candidate task prompts (originating from a particular one of the language model servers 502) comprising instructions defining a particular processing task be performed on input data. The input data subregion 582 may be configured to receive user input (originating from a particular one of the user devices 504) comprising the input data. In some embodiments, the input data subregion 582 may also receive LLM generated candidate input data (originating from a particular one of the language model servers 502). The instructions received in the instructions subregion 580 may define any processing task to be performed by an LLM on the input data received in the input data subregion 582 known to one of ordinary skill in the art. For example, the instructions received in the instructions subregion 580 may comprise “translate the input data into Spanish” defining a translation processing task, and the input data received in the input data subregion 582 may comprise at least one text string. In other embodiments, the instructions may comprise “summarize the input data in 10 sentences or less” defining a summarization processing task, and the input data may comprise a longer text and may include multiple paragraphs or multiple pages of text. In other embodiments, the instructions may comprise “generate a poem based on the input data” defining a text generation task, and the input data may comprise at least one text string. In yet other embodiments, the instructions may comprise “compare texts A and B in the input data” defining a comparison processing task, and the input data may comprise at least text A and text B.

The task prompt input button 584 may enable users associated with the user devices to input a candidate task prompt received in the task prompt region 564 into a language model selected using the language model selector 562. For example, in embodiments where the language model selector 562 is utilized to select “GPT-4” as the LLM into which the candidate task prompt is inputted, selection of the task prompt input button 584 may cause the prompt modification server 506 to transmit the candidate task prompt in the task prompt region 564 to the language model server 502A via the I/O interface 526 for input into GPT-4 stored/hosted thereon.

The candidate output region 566 may generally be configured to iteratively receive different candidate outputs generated by the LLM stored/hosted on the language model servers 502 and in response to the task prompt (e.g., including the instructions received in the instructions subregion 580 and the input data received in the input data subregion 582). In the embodiment shown in FIG. 5, the candidate output region 566 includes an output display subregion 590, a user comment subregion 592, a user score subregion 594 and a user flag subregion 596. Some embodiments of the candidate output region 566 may not include all of the user comment subregions 592, the user score subregions 594 and the user flag subregions 596, and may only include one or only include two of the subregions.

The output display subregion 590 may be configured to iteratively display at least one candidate output generated by the LLM (e.g., stored/hosted on the language model servers 502) in response to the candidate task prompt received in the task prompt region 564 (e.g., including the instructions received in the instructions subregion 580 and the input data received in the input data subregion 582). In the embodiment shown in FIG. 5, the candidate output region 566 includes a plurality of output display subregions 590 (illustrated as 596A-B in FIG. 5, reference character “590” as used herein may refer to any one output display subregion of the plurality of output display subregions or the plurality of output display subregions as a whole), each of which may be associated with a corresponding candidate output generated by the LLM. Utilizing the example described above, whereby the instruction in the instructions subregion 580 comprise “Translate the input data into Spanish” and the input data received in the input data subregion 582 comprise “I found the shoes to be comfortable”, the first output display subregion 590A may receive and display a first candidate output of “Los zapatos me parecieron cómodos” while the second output display subregion 590B may receive and display and display a second candidate output of “El calzado me pareció cómoda.”

The user comment subregion 592 may be configured to iteratively receive user input comprising comments on one or both of (a) the at least one candidate output generated by the LLM and displayed in the output display subregion 590 and (b) the candidate task prompt received in the task prompt region 564 and used by the LLM to generate the at least one candidate output. The expression “comment” as used herein refers to any text string, assessments, and/or evaluations provided by a user (e.g., via the user interface of a particular one of the user devices 504) related to the at least one candidate output and/or the candidate task prompt used to generate the at least one candidate output. The user comment subregion 592 may allow for free-form text feedback by the user (e.g., “I would prefer a table format”, “Too much detail, find factual points and create a table based on the example table provided below”). The comments may also include text editing of the actual content of the at least candidate outputs generated by the LLM and displayed in the output display subregion 590, including records of deletions and insertions of text.

In the embodiment shown in FIG. 5, the candidate output region 566 includes a plurality of user comment subregions 592 (illustrated as 592A-C in FIG. 5, reference character “592” as used herein may refer to any one user comment subregion of the plurality of user comment subregions or the plurality of user comment subregions as a whole). Some of the user comment subregions 592 (e.g., the user comment subregions 592A-B) may be associated with a corresponding one of the output display subregions 590, such that the comments received in these user comment subregions 592 may generally be associated with the candidate output displayed in the corresponding output display subregion 590. For example, continuing to utilize the example of the translation processing task described above, first comments (e.g., “Good translation”) received in the first user comment subregion 592A may be directed to the first candidate output of “Los zapatos me parecieron cómodos” displayed in the corresponding first output display subregion 590A, while second comments (e.g., “Modify to be gender neutral”) received in the second user comment subregion 592B may be directed to the second candidate output of “El calzado me pareció cómoda” displayed in the corresponding second output display subregion 590B. However, other ones of the user comment subregions 592 (e.g., the user comment subregion 592C) may be associated with entire candidate output region 566 as a whole, such that the comments received in these user comment subregions 592 may be more generally associated with all the candidate outputs displayed in the candidate output region 566. For example, an overall comment (e.g., “Generally good”) received in the user comment subregion 592C may be associated with both the first and second candidate outputs received in the first and second user comment subregions 592A-B.

The user score subregion 594 may be configured to iteratively receive user input comprising a score of one or both of (a) the at least one candidate output generated by the LLM and displayed in the output display subregion 590 and (b) the candidate task prompt received in the task prompt region 564 and used by the LLM to generate the at least one candidate output. The expression “score” as used herein refers to any comparative rating provided by a user (e.g., via the user interface of a particular one of the user devices 504) related to the at least one candidate output and/or the candidate task prompt. The score may be an alphanumerical score, an alphabetical score and/or a numerical score which is fixed across a particular processing task (e.g., ratings of A1-A5 to D1-D5 with: A being the highest and D being the lowest and then 1 being the lowest and 5 being the highest; or A being a first category of scoring (e.g., “cost”), B being a second category of scoring (e.g., “user score”), C being a third category of score (e.g., “synthetic score” (scoring by another LLM)), and then 1 being the lowest and 5 being the highest in each category of scoring). The score may also be a relative score comparing candidate prompts and/or candidate outputs (e.g., for two candidate outputs A and B generated in response to a particular candidate prompt, ratings of “A is better”, “B is better”, “A and B are the same”). In some embodiments, a portion of the score may be machine-generated, and each score may be associated with a defined machine-generated threshold of the candidate task prompt and/or at least one candidate output, such as a perplexity threshold, a language diversity threshold (e.g., tf-idf, n-gram diversity), etc.

In the embodiment shown in FIG. 5, the candidate output region 566 includes a plurality of user score subregions 594 (illustrated as 594A-B in FIG. 5, reference character “594” as used herein may refer to any one user score subregion of the plurality of user score subregions or the plurality of user score subregions as a whole). Each of the user score subregions 594 (e.g., the user score subregions 594A-B) may be associated with a corresponding one of the output display subregions 590, such that the score received in these user score subregions 594 may generally be associated with the candidate output displayed in the corresponding output display subregion 590. For example, continuing to utilize the example of the translation processing task described above, a first score (e.g., “4”) received in the first user score subregion 594A may be directed to the candidate output of “Los zapatos me parecieron cómodos” displayed in the corresponding first output display subregion 590A, while a second score (e.g., “2”) received in the second user score subregion 594B may be directed to the candidate output of “El calzado me pareció cómoda” displayed in the corresponding second output display subregion 590B.

The user flag subregion 596 may be configured to iteratively receive user input prompt comprising label to be associated with of one or both of (a) the at least one candidate output generated by the LLM and displayed in the output display subregion 590 and (b) the candidate task prompt received in the task prompt region 564 and used by the LLM to generate the at least one candidate output. The expression “flag” as used herein refers to any flag that can be associated with the at least one candidate output and/or the candidate task prompt to indicate a condition thereof. The flags may identify particularly good candidate prompts and/or outputs (i.e., gold standard) or content which should be moderated (i.e., forbidden content). For example, in the embodiment shown in FIG. 5, the flag includes a “gold standard” flag to indicate that the at least one candidate output is of particularly good quality and may be used as an example of desirable output in the modification prompt and/or the candidate task prompt inputted into the LLMs. Accordingly, some flag selections may also modify a format of the modification prompt and/or the candidate task prompt inputted into the LLMs. Other flags (not shown) may include a “gold standard content” flag indicating that the content of the at least one candidate output is of particularly good quality and/or a “gold standard format” flag indicating that the formatting of the at least one candidate output is of particularly good quality.

In the embodiment shown in FIG. 5, the candidate output region 566 includes a plurality of user flag subregions 596 (illustrated as 596A-B in FIG. 5, reference character “596” as used herein may refer to any one user flag subregion of the plurality of user flag subregions or the plurality of user flag subregions as a whole). Each of the user flag subregions 596 (e.g., the user flag subregions 596A-B) may be associated with a corresponding one of the output display subregions 590, such that the flags selected in these user flag subregions 596 may be associated with the candidate output displayed in the corresponding output display subregion 590. For example, continuing to utilize the example of the translation processing task described above, a first flag (e.g., “goldstandard_1”) received in the first user flag subregion 596A may be directed to the first candidate output of “Los zapatos me parecieron cómodos” displayed in the corresponding first output display subregion 590A, while a second flag (e.g., “goldstandard_null”) received in the second user score subregion 594B may be directed to the second candidate output of “El calzado me pareció cómoda” displayed in the corresponding second output display subregion 590B.

The modify prompt region 568 may generally be configured to iteratively display different candidate task prompts generated by LLMs stored/hosted on the language model servers 502 and in response to a modification prompt. The modification prompt may include at least the user input comprising the comments, the scores and/or the flag selections entered using the candidate output region 566 (e.g., any user input received in the user comment subregions 592, the user score subregions 594 and/or the user flag subregions 596) and as described above. In some embodiments, the modification prompt may also include at least one of (a) instructions directing the LLM to modify the candidate task prompt in view of the user input and (b) one or more components of the candidate task prompt received in the language model selector 562 (e.g., the input data received in the input data subregion 582 and/or the candidate instructions received in the instructions subregion 580).

In the embodiment shown in FIG. 5, the modify prompt region 568 includes a modification prompt input button 600, a prompt display subregion 602 and a transfer prompt button 604. The modification prompt input button 600 may enable users associated with the user devices 504 to input the modification prompt into a language model selected using the language model selector 562. For example, in embodiments where the language model selector 562 is utilized to select “GPT-4” as the LLM into which the modification prompt is inputted, user selection of the modification prompt input button 600 may cause the prompt modification server 506 to transmit the modification prompt to the language model server 502A via the I/O interface 526 for input into GPT-4 stored/hosted thereon.

The prompt display subregion 602 may be configured to iteratively display a candidate task prompt generated by the LLM in response to the modification prompt. For example, continuing to utilize the utilize the example of the translation processing task described above, whereby the second candidate output comprises “El calzado me pareció cómoda” displayed in the corresponding second output display subregion 590B and the user input comprises (a) “Modify to be gender neutral” inputted in the corresponding second user comment subregion 592B, (b) “2” inputted in the corresponding second user score subregion 594B, and (c) “gold standard_null” received in the corresponding second user flag subregion 596B, the prompt display subregion 602 may receive and display a subsequent candidate task prompt of “Translate the input data into Spanish, utilizing gender-neutral nouns and gender-neutral verbs where possible”. The subsequent candidate task prompt may be different from the current candidate task prompt displayed in the task prompt region 564 and may specifically include different instructions than the current instructions displayed in the instructions subregion 580. The prompt display subregion 602 may also allow users associated with the user devices 504 to further modify and/or amend the subsequent candidate task prompt initially generated by the LLM and displayed in the prompt display subregion 602 (e.g., using the user interface of the one of the user devices 504), including deletions and insertions of text of the subsequent candidate task prompt.

The transfer prompt button 604 may enable users associated with the user devices 504 to automatically transfer the subsequent candidate task prompt displayed in the prompt display subregion 602 (e.g., either as generated by the LLM or after modification by the user) as the current candidate task prompt received in the task prompt region 564 (e.g., received in the instructions subregion 580). Continuing to utilize the example of the translation processing task described above described above, selection of the transfer prompt button 604 may copy “Translate the input data into Spanish, utilizing gender-neutral translations where possible” displayed in the prompt display subregion 602 to the instructions subregion 580. Automatic population of the task prompt region 564 with the subsequent candidate task prompt displayed in prompt display subregion 602 may further facilitate efficient interactions between users of the user devices 504 and the LLM.

### Progress Display 610

The progress display 610 produced by the user interface codes 550 for display on the displays of the user devices 504 in accordance with one embodiment is illustrated in FIG. 6. In the embodiment shown, the progress display 610 displays a plurality of nodes 612 (illustrated as 612A-F in FIG. 6, reference character “612” as used herein may refer to any one node of the plurality of nodes or the plurality of nodes as a whole) and a plurality of edges 614 (illustrated as 614A-E in FIG. 5, reference character “614” as used herein may refer to any one edge of the plurality of edges or the plurality of edges as a whole). Each of the nodes 612 may be associated with a candidate task prompt and at least one candidate output generated by an LLM using the task prompt. Each of the edges 614 may be associated with a modification prompt and at least one candidate task prompt generated by an LLM using the modification prompt. Generally, the progress display 610 may allow users of the user devices 504 to select a node of the nodes 612 to re-evaluate a previous candidate task prompt and at least one previous candidate output associated with the selected node, and to re-evaluate or re-engineer the previous candidate task prompt and/or previous candidate output.

In some embodiments, the nodes 612 and edges 614 displayed as a whole may relate to a particular processing task to be performed by an LLM, such that different sets of the nodes 612 and the edges 614 relate to different processing tasks. Additionally or alternatively, the nodes 612 and the edges 614 as a whole may relate to a particular user of the user devices 504, such that different sets of the nodes 612 and the edges 614 may instead relate to task prompt evaluation and/or engineering performed by different users.

In the embodiment shown in FIG. 6, a first node 612A and a second node 612B may be connected by an edge 614B when the first node 612A is associated with a first task prompt and at least one first candidate output and the second node 612B is associated with a second task prompt generated by an LLM utilizing a modification prompt (e.g., associated with the edge 614B) comprising user input directed to the first task prompt and/or the at least one first candidate output. Again continuing to utilize the example of the translation processing task described above, the first node 612A may be associated with an initial candidate task prompt comprising <instructions=“Translate the input data into Spanish”, input data=“I found the shoes to be comfortable”>, the first candidate output comprising <candidate output 1=“Los zapatos me parecieron cómodos” >, and the second candidate output comprising <candidate output 2=“El calzado me pareció cómoda” >. The second node 612B may be associated with the subsequent candidate task prompt generated by the LLM comprising <instructions=“Translate the input data into Spanish, utilizing gender-neutral nouns and gender-neutral verbs where possible”, input data=“I found the shoes to be comfortable”>. The edge 614A connecting the first and second nodes 612A and 612B may comprise the first modification prompt comprising <candidate output 1 user input=“Good translation, 4, goldstandard_1”, candidate output 2 user input=“Modify to be gender neutral, 2, goldstandard_0”>, whereby the subsequent candidate task prompt of the second node 612B is generated based on user input directed to the first task prompt and/or the at least one first candidate output of the first node 612A.

Each of the nodes 612 of the progress display 610 may enable users associated with the user devices 504 to select a previous candidate task prompt and a previous at least one candidate output generated based on the previous task prompt to re-evaluate or re-engineer the previous task prompt. For example, in response to selection of a particular node 612B by a user associated with a particular user device 504, the prompt modification server 506 may cause the display of the particular user device 504 to display the candidate template 560 (shown in FIG. 5) such that the candidate task prompt associated with the selected node 612B is automatically displayed in the task prompt region 564 and the at least one candidate output (generated by an LLM based on the candidate task prompt) associated with the selected node 612B is automatically displayed in the candidate output region 566. Automatically populating the candidate template 560 with a previous candidate task prompt and at least one previous candidate output can provide an efficient backtracking mechanism for users to re-evaluate and re-engineer previous iterations of candidate task prompts and candidate outputs. Depending on whether the user provides different user inputs via the user comment subregions 592, the user score subregions 594 and/or the user flag subregions 596 of the candidate output region 566, the modification prompt may be different and the LLM may generate a different subsequent candidate task prompt which may in turn be used to generate at least one different candidate output. The different modification prompt may be stored and displayed as a separate edge (e.g. edge 614C) in the progress display 610. The different subsequent candidate task prompt used to generate different candidate outputs may be displayed as a separate node (e.g., node 612D) in the progress display 610.

### Modify Task Prompt Process 650

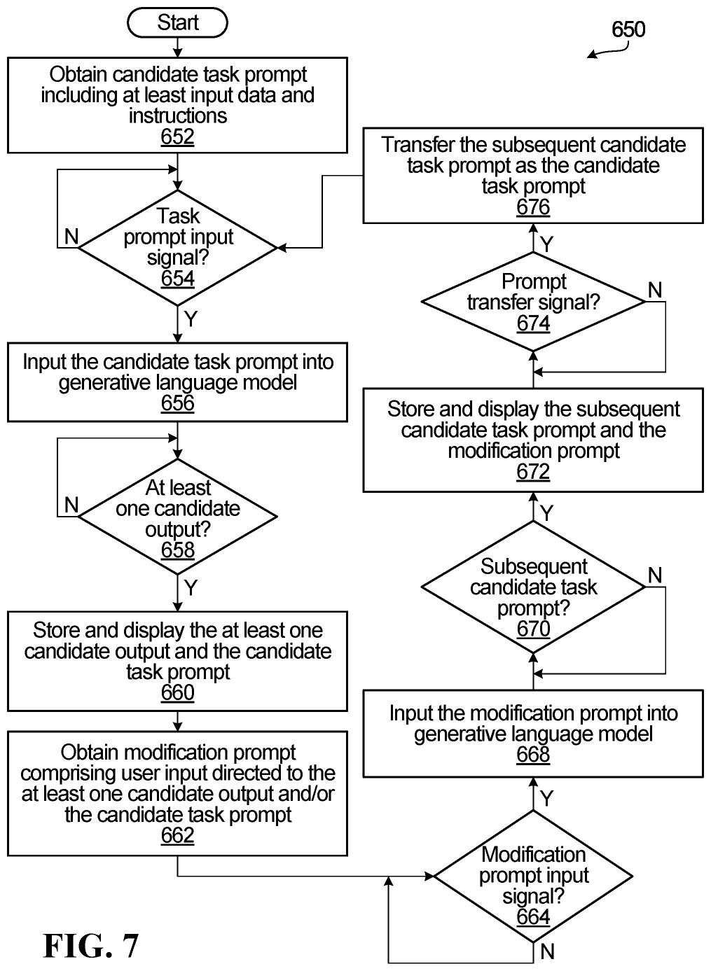

Referring to FIGS. 3 and 7, a computer-implemented modify task prompt process for generating subsequent candidate task prompts using an LLM is generally shown at 650. As described above, utilizing LLMs to generate subsequent candidate task prompts can allow both subsequent candidate task prompts and candidate outputs to be generated with the assistance of LLMs, which may remove the onus on users to independently develop or engineer language of candidate task prompts.

In the embodiment shown, the modify task prompt process 650 is performed by the prompt modification processor 520 executing processor, machine and/or computer readable instructions stored in the program memory 524. In other embodiments, the modify task prompt process 650 may comprise processor, machine and/or computer readable instructions alternatively stored on other non-transitory computer readable storage medium such as a CD-ROM, a floppy disk, a hard drive, a DVD, a Blu-ray disk or another component associated with the prompt modification server 506; in yet other embodiments, the modify task prompt process 650 and/or parts thereof could alternatively be executed by a device other than the prompt modification processor 520, including for example, by the language model servers 502 and/or the user devices 504. Further, although the modify task prompt process 650 in accordance with one embodiment is described with reference to the flowchart illustrated in FIG. 7, other methods of implementing the modify task prompt process 650 may alternatively be used. For example, the order of execution of the blocks shown in FIG. 7 may be altered, and/or some of the blocks described may be altered, eliminated, or combined.

In the embodiment shown in FIG. 7, the modify task prompt process 650 begins at block 652, which may include codes directing the prompt modification processor 520 to obtain a candidate task prompt including input data and candidate instructions for processing the input data. For example, block 652 may direct the prompt modification processor 520 to cause a display of a particular user device 504 to display the candidate template 560 (shown in FIG. 5) prompting a user of the particular user device 504 to input the candidate task prompt in a structured manner. Block 652 may then direct the prompt modification processor 520 to wait to receive candidate instructions in the instructions subregion 580 and input data in the input data subregion 582. The candidate instructions and the input data may be inputted by a user associated with the user device 504, such as by using the user interface associated with the user device 504. The candidate task prompt may also comprise a subsequent candidate task prompt generated by an LLM in response to a modification prompt after block 676 of the modify task prompt process 650 as described below. In some embodiments, the input data may also comprise candidate input data generated by an LLM.

As described above, the instructions define a particular processing task to be performed on the input data and the input data may vary depending on the processing task to be performed on the input data. The instructions obtained at block 652 may define any processing task to be performed by an LLM on the input data known to one of ordinary skill in the art, including without limitation translation processing tasks, summarization processing tasks, generative processing tasks, comparative processing tasks etc. for example, continuing to utilize the example of the translation processing task described above, the candidate task prompt may define the translation processing task and comprise (a) candidate instructions comprising “Translate the input data into Spanish” and (b) input data comprising “I found the shoes to be comfortable”. As another non-limiting example, the candidate task prompt may instead define a comparison processing task and comprise (a) candidate instructions comprising “Compare review summary A and review summary B and tell me what is different” and (b) input data comprising “<review summary A=“Merchants appreciate this app for its wide range of customizable products and seamless integration. Its user-friendly interface is a plus, but some find the product pricing steep. Customer service experiences vary, with some reporting slow responses and unresolved issues. Complaints include long shipping times, high costs, and inconsistent product quality.”, review summary B=“Merchants highly recommend this app for its extensive range of customizable products and top-notch quality. Integrates well with E-commerce platforms, streamlining the selling and order management process. Many appreciate the quick and efficient customer service, especially the live chat support. The app offers speedy shipping options and competitive pricing”>.

In some other embodiments, the candidate task prompt may include additional context associated with the candidate instructions and/or the input data. Context may provide examples of desirable output or define features of desirable outputs to be generated by the LLM, may provide additional external information regarding the candidate task prompt and/or the input data. Utilizing the example of the translation processing task described above, additional context may comprise “The input data relates to a review on shoe A offered by manufacturer B”. Utilizing the example of the comparison processing task described above, additional context may comprise “Summarize the differences without going into excessive detail”. This additional context may be obtained via user input or LLM generation received in a separate context subregion (not shown) of the task prompt region 564 of the candidate template 560; alternatively or additionally, this additional context may be obtained via user input or LLM generation received in the instructions subregion 580 (shown in FIG. 5).

The modify task prompt process 650 then proceeds to optional block 654, which may include codes directing the prompt modification processor 520 to optionally wait for a task prompt input signal. For example, a user of the particular user device 504 may continue to modify the candidate task prompt received in the task prompt region 564 until the user is satisfied with the specific language of the candidate task prompt. Thereafter, the user may select the task prompt input button 584 of the candidate template 560 (shown in FIG. 5) to generate the task prompt input signal.

The modify task prompt process 650 may direct the prompt modification processor 520 to wait at block 654 until the task prompt input signal is received. If at block 654, the prompt modification processor 520 determines that the task prompt input signal has been received, the modify task prompt process 650 may then proceed to block 656, which may include codes directing the prompt modification processor 520 to input the candidate task prompt obtained at obtained at block 652 to a generative language model. For example, block 656 may direct the prompt modification processor 520 to input the candidate task prompt comprising the candidate instructions received in the instructions subregion 580, the input data received in the input data subregion 582 and any additional context received in the task prompt region 564 to a language model server 502 hosting/storing an LLM selected for candidate task prompts using the language model selector 562 (shown in FIG. 5).

The modify task prompt process 650 then proceeds to block 658, which may include codes directing the prompt modification processor 520 to wait to receive at least one candidate output generated by the generative language model in response to the candidate task prompt inputted at block 656. For example, the LLM selected for candidate task prompts may process the candidate task prompt and may generate at least one candidate output. In some embodiments, the selected LLM may generate a single candidate output in response to a particular candidate task prompt. However, in other embodiments, the selected LLM may generate a plurality of candidate outputs in response to a particular candidate task prompt. For example, inputting the candidate task prompt into the selected LLM to generate an initial candidate output, adjusting hyperparameters (e.g., context window length, token selection probability (e.g., “temperature”, top-k and top-p), content moderated sequences, frequency penalty versus presence penalty) of the selected LLM, inputting the same candidate task prompt into the modified selected LLM may generate a candidate output different from the initial candidate output in response to one candidate task prompt. Additionally or alternatively, if the selected LLM has lower threshold hyperparameters (e.g., lower threshold token selection probability hyperparameters), the selected LLM may also generate more than one initial candidate output in response to one candidate task prompt. Additionally or alternatively, if the input data includes separate sets of input data to be processed via the particular processing task (e.g., a first phrase, a second phrase and a third phrase all to be translated, or reviews 1 and 2 to be compared as well as reviews 3 and 4 to be compared), the selected LLM may generate a corresponding candidate output for each set of input data.

Utilizing the example of the translation processing task described above, the selected LLM into which the current candidate task prompt is inputted may be GPT-4 hosted/stored by the language model server 502A. In response to the candidate task prompt for the translation processing task, the at least one candidate output generated by GPT-4 may comprise the first candidate output of “Los zapatos me parecieron cómodos” and the second candidate output of “El calzado me pareció cómoda.”, both of which may be transmitted by the language model server 502A to the prompt modification server 506. Utilizing the example of the comparison processing task described above, the selected LLM may also be GPT-4 hosted/stored by the language model server 502A. In response to the candidate task prompt for the comparison processing task, the candidate output generated by GPT-4 may comprise “Review A highlights some negative aspects of the app, such as the product pricing, slow customer service response, unresolved issues, long shipping times, high costs, inconsistent product quality, and technical issues. Review B presents a more positive view of the app. It emphasizes the extensive range of customizable products, top-notch quality, good integration with e-commerce platforms, efficient customer service, and competitive pricing.”, which may be transmitted by the language model server 502A to the prompt modification server 506.

The modify task prompt process 650 may direct the prompt modification processor 520 to wait at block 658 until the at least one candidate output generated by the selected LLM in response to the candidate task prompt is received. If at block 658, the prompt modification processor 520 determines that the at least one candidate output generated by the selected LLM has been received, the modify task prompt process 650 may proceed to block 660, which may include codes directing the prompt modification processor 520 to store and display the at least one candidate output. For example, block 660 may direct the prompt modification processor 520 to store the at least one candidate output received at block 658 (e.g., generated by the selected LLM) associated together with the candidate task prompt inputted at block 656 (e.g., inputted into the selected LLM to generate the at least one candidate output) as a node entry (e.g., forming one of the nodes 612) in the node datastore 651 described above for example. As an additional example, block 660 may also direct the prompt modification processor 520 to cause the display of the particular user device 504 to display the at least one candidate output received at block 658 in the output display subregion 590 of the candidate template 560 (shown in FIG. 5) prompting the user of the particular user device 504 to provide user input directed to one or both of the at least one candidate output received at block 658 and the candidate task prompt inputted at block 656.

The modify task prompt process may then proceed to block 662, which may include codes directing the prompt modification processor 520 to receive user input directed to one or both of the at least one candidate output received at block 658 and the candidate task prompt inputted at block 656. For example, block 662 may direct the prompt modification processor 520 to wait to receive user input comprising at least one of comments in the user comment subregions 592, scores in the user score subregions 594 and flag selections in the user flag subregions 596 of the candidate template 560 (shown in FIG. 5). As described above, user input comprising one or more of the comments, the scores and/or the flags may be based on an assessment of the candidate task prompt and/or the candidate outputs generated by the selected LLM, including, relevance, fluency, coherence and format thereof.

Utilizing the example of the translation processing task described above, user input on the first candidate output of “Los zapatos me parecieron cómodos” displayed in the first output display subregion 590A may comprise (a) comment of “Good translation” received in the user comment subregion 592A, (b) score of “4” received in the user score subregion 594A, and (c) flag status of “gold standard_1” received in the user flag subregion 596A. In contrast, user input on the second candidate output of “El calzado me pareció cómoda” displayed in the corresponding second output display subregion 590B may comprise (a) comment of “Modify to be gender neutral” received in the user comment subregion 592B, (b) score of “2” received in the user score subregion 594B, and (c) “gold standard_null” received in the user flag subregion 596B. Utilizing the example of the comparison processing task described above, user input on the candidate output of “Review A highlights some negative aspects of the app, such as the product pricing, slow customer service response, unresolved issues, long shipping times, high costs, inconsistent product quality, and technical issues. Review B presents a more positive view of the app. It emphasizes the extensive range of customizable products, top-notch quality, good integration with e-commerce platforms, efficient customer service, and competitive pricing” displayed in the output display subregion 590 may comprise (a) comment of “I want to have a side-by-side factual comparison of whether a point was mentioned in the review A or review B. Create a markdown table with such factual comparisons.” in the user comment subregion 592.

The modify task prompt process 650 then continues to optional block 664, which may include codes directing the prompt modification processor 520 to optionally wait for a modification prompt input signal. For example, the user of the particular user device 504 and may continue to generate user input directed to one or both of the at least one candidate output and the candidate task prompt using the candidate output region 566 until the user is generally satisfied with the specific language of the user input and/or the at least one candidate output. Thereafter, the user may select the modification prompt input button 600 of the candidate template 560 (shown in FIG. 5) to generate the modification prompt input signal.

The modify task prompt process 650 may direct the modification processor 520 to wait at block 664 until the modification prompt input signal is received. If at block 664, the modification processor 520 determines that the modification prompt input signal has been received, the modify task prompt process 650 may then proceed to block 668, which may include codes directing the prompt modification processor 520 to input at least the user input received at block 662 into a generative language model as a modification prompt. The modification prompt may further include one or more of (a) instructions directing the language model to modify the candidate task prompt received at block 656 in view of the user input received at block 662 and (b) one or more components of the initial candidate task prompt (e.g., the input data, the candidate instructions and/or the candidate context).

Utilizing the example of the translation processing task described above, the modification prompt may comprise (a) instructions comprising “Adapt initial candidate task prompt in view of user input on candidate outputs”; (b) context/input data comprising: <initial candidate task prompt=“Translate the input data into Spanish”, candidate output 1=“Los zapatos me parecieron cómodos”, and candidate output 2=“El calzado me pareció cómoda” >, and (c) user input comprising: <candidate output 1 user input=“Good translation, 4, goldstandard_1”, candidate output 2 user input=“Modify to be gender neutral, 2, goldstandard_0”>. Utilizing the example of the comparison processing task described above, the modification prompt may comprise (a) instructions comprising “Adapt initial candidate task prompt in view of user input on candidate outputs”; (b) context/input data comprising: <initial candidate task prompt=“Compare review summary A and review summary B and tell me what is different”, candidate output 1=“Review A highlights some negative aspects of the app, such as the product pricing, slow customer service response, unresolved issues, long shipping times, high costs, inconsistent product quality, and technical issues. Review B presents a more positive view of the app. It emphasizes the extensive range of customizable products, top-notch quality, good integration with e-commerce platforms, efficient customer service, and competitive pricing”>, and (c) user input comprising: <candidate output 1 user input=“I want to have a side-by-side factual comparison of whether a point was mentioned in the review A or review B. Create a markdown table with such factual comparisons”>.

In the embodiment shown, the LLM which generates both the subsequent (e.g., modified) candidate task prompt (in response to the modification prompt) and the at least one candidate output (in response to the candidate task prompt) is the same LLM, and may specifically be GPT-4 hosted/stored by the language model server 502A. Using a single LLM to receive both modification prompts and candidate task prompts may improve the efficiency of using a particular LLM in performing a processing task, as the LLM can itself be used iteratively to refine and improve language of a candidate task prompt to be inputted into the LLM for that processing task. Further, utilizing a same LLM to generate both the candidate outputs and the candidate task prompts may facilitate consistency in the outputs and the task prompts generated. However, in other embodiments, the LLM which generates the modified candidate task prompt in response to the modification prompt may be different LLMs. For example, PaLM 2 hosted/stored by the language model server 502C may be used to generate the at least one candidate output (in response to the candidate task prompt inputted at block 656) and the GPT-4 hosted/stored by the language model server 502A may be used to generate the modified candidate task prompt (in response to the modification prompt inputted at block 668). Such embodiments may be used when one LLM is more adapted to a particular processing task but the second LLM is more adapted to the prompt modification task.

Utilizing the example of the translation processing task described above, the modification prompt may comprise (a) instructions comprising “Adapt initial candidate task prompt in view of user input on candidate outputs”; (b) context/input data comprising: <initial candidate task prompt=“Translate the input data into Spanish”, candidate output 1=“Los zapatos me parecieron cómodos”, and candidate output 2=“El calzado me pareció cómoda” >, and (c) user input comprising: <candidate output 1 user input=“Good translation, 4, goldstandard_1”, candidate output 2 user input=“Modify to be gender neutral, 2, goldstandard_0”>. Utilizing the example of the comparison processing task described above, the modification prompt may comprise (a) instructions comprising “Adapt initial candidate task prompt in view of user input on candidate outputs”; (b) context/input data comprising: <initial candidate task prompt=“Compare review summary A and review summary B and tell me what is different”, candidate output 1=“Review A highlights some negative aspects of the app, such as the product pricing, slow customer service response, unresolved issues, long shipping times, high costs, inconsistent product quality, and technical issues. Review B presents a more positive view of the app. It emphasizes the extensive range of customizable products, top-notch quality, good integration with e-commerce platforms, efficient customer service, and competitive pricing”>, and (c) user input comprising: <candidate output 1 user input=“I want to have a side-by-side factual comparison of whether a point was mentioned in the review A or review B. Create a markdown table with such factual comparisons”>.

The modify task prompt process 650 then proceeds to block 670, which may include codes directing the prompt modification processor 520 to wait to receive a subsequent candidate task prompt generated by the generative language model in response to the modification prompt inputted into the generative language model at block 668. The subsequent candidate task prompt may be different from the initial candidate task prompt obtained or otherwise received at block 652 and may take into account the user input within the modification prompt inputted at block 668. The subsequent candidate task prompt may specifically include modified candidate instructions which are different from the candidate instructions based on the user input within the modification prompt. Utilizing the user input to instruct the LLM to re-generate candidate task prompts allows the LLM itself to be used iteratively to refine the language of candidate prompts with user guidance, but removes the onus on users to independently develop or modify the language of candidate task prompts.

Utilizing the example of the translation processing task described above, the selected LLM into which the modification prompt is inputted may be GPT-4 hosted/stored by the language model server 502A. In response to the modification prompt for the translation processing task, the subsequent candidate task prompt generated by GPT-4 may comprise “Translate the input data into Spanish, utilizing gender-neutral nouns and gender-neutral verbs where possible”, which is different from the initial candidate task prompt of “Translate the input data into Spanish” initially received or obtained at block 652. Utilizing the example of the comparison processing task described above, the selected LLM into which the modification prompt is inputted may also be GPT-4 hosted/stored by the language model server 502A. In response to the modification prompt for the comparison processing task, the subsequent candidate task prompt generated by GPT-4 may comprise “In the two review summaries given in the input data, conduct a comparison and identify the key points mentioned by either version. Please present your findings in a markdown table with the following format: |Keypoint|Mentioned in Review A|Sentiment in Review A|Mentioned in Review B|Sentiment in Review B|”, which is different from the initial candidate task prompt of “Compare review summary A and review summary B and tell me what is different” initially received or obtained at block 652.

The modify task prompt process 650 may direct the prompt modification processor 520 to wait at block 670 until the subsequent candidate task prompt generated by the selected LLM is received. If at block 670, the prompt modification processor 520 determines that the subsequent candidate task prompt generated by the selected LLM has been received, the modify task prompt process 650 may proceed to block 660, which may include codes directing the prompt modification processor 520 to store and display the subsequent candidate task prompt. For example, block 660 may direct the prompt modification processor 520 to store the modification prompt inputted at block 668 (e.g., inputted into the selected LLM to generate the at least one candidate task prompt) associated together with the subsequent candidate task prompt generated at block 670 (e.g., generated by the selected LLM) as an edge entry (e.g., forming one of the edges 614) in the edge datastore 653 as described above for example. The edge entry may identify the node entry generated at block 660 as described above. As an additional example, block 672 may also direct the prompt modification processor 520 to cause the display of the particular user device 504 to display the subsequent candidate task prompt received at block 668 in the prompt display subregion 602 of the candidate template 560 (shown in FIG. 5). The subsequent candidate task prompt in the prompt display subregion 602 may be further edited by a user (e.g., via the user interface of the user devices 504).

The modify task prompt process 650 then proceeds to optional block 674, which may include codes directing the prompt modification processor 520 to optionally wait for a prompt transfer signal. For example, users of the user devices 504 may continue to modify the subsequent candidate task prompt using prompt display subregion 602 of the candidate template 560 until the user is satisfied with the specific language of the subsequent candidate task prompt. Thereafter, the user may select the transfer prompt button 604 of the candidate template 560 (shown in FIG. 5) to generate the prompt transfer signal.

The modify task prompt process 650 may direct the prompt modification processor 520 to wait at block 674 until the transfer prompt signal is received. If at block 674, the prompt modification processor 520 determines that the transfer prompt signal has been received, the modify task prompt process 650 may proceed to block 676, which may include codes directing the prompt modification processor 520 to automatically transfer the subsequent candidate task prompt displayed in the prompt display subregion 602 (e.g., either as generated by the LLM or after modification by the user) as the current candidate task prompt received in the task prompt region 564 (e.g., particularly received in the instructions subregion 580).

Continuing to utilize the example of the translation processing task described above described above, selection of the transfer prompt button 604 may copy “Translate the input data into Spanish, utilizing gender-neutral translations where possible” displayed in the prompt display subregion 602 to the instructions subregion 580. Automatic population of the task prompt region 564 with the subsequent candidate task prompt displayed in prompt display subregion 602 may further facilitate efficient interactions between users of the user devices 504 and the LLM.

Utilizing the example of the translation processing task described above, block 676 may direct the prompt modification processor 520 to replace the current candidate input prompt comprising “Translate the input data into Spanish” initially received or obtained at block 652 and displayed in the instructions subregion 580 with the subsequent candidate input prompt comprising “Translate the input data into Spanish, utilizing gender-neutral nouns and gender-neutral verbs where possible” received or obtained at block 672 and displayed in the prompt display subregion 602. Utilizing the example of the comparison processing task described above, block 676 may direct the prompt modification processor 520 to replace the current candidate input prompt comprising “Compare review summary A and review summary B and tell me what is different” initially received or obtained at block 652 and displayed in the instructions subregion 580 with the subsequent candidate task prompt comprising “In the two review summaries given in the input data, conduct a comparison and identify the key points mentioned by either version. Please present your findings in a markdown table with the following format: |Keypoint|Mentioned in Review A |Sentiment in Review A|Mentioned in Review B|Sentiment in Review B|” received or obtained at block 672 and displayed in the prompt display subregion 602.

The modify task prompt process 650 may then continue from block 654 with the subsequent candidate task prompt replacing the initial candidate task prompt in each subsequent block to generate a further subsequent candidate task prompt. For example, the modify task prompt process 650 may direct the prompt modification processor 520 to (a) input at least the subsequent candidate task prompt back into the selected LLM (e.g., repeat block 656 with the subsequent candidate task prompt as the candidate task prompt) and to receive, from the selected LLM and responsive to input of the subsequent candidate task prompt, at least one subsequent candidate output generated by the generative language model; (b) receive subsequent user input directed to one or both of the subsequent candidate task prompt and the at least one subsequent candidate output (e.g., repeat block 662 with the at least one subsequent candidate output as the at least one candidate output and the subsequent candidate task prompt as the candidate task prompt); (c) input the subsequent user input and one or both of the subsequent candidate task prompt and the at least one subsequent candidate output into the selected LLM as a subsequent modification prompt (e.g. repeat block 668 with the subsequent user input as the user input) and receive, from the selected LLM and responsive to input of the subsequent modification prompt, a further subsequent candidate prompt.

The combination of the candidate template 560 and the modify task prompt process 650 may generally allow the prompt modification server 506 to iteratively input successive candidate task prompts generated by selected LLMs back into the LLMs to generate corresponding successive at least one candidate outputs; iteratively receive user input directed to one or more of the successive candidate task prompts and the corresponding successive at least one candidate outputs; and to iteratively input the user input and one or more of the successive candidate task prompts and the corresponding successive at least one candidate outputs back into selected LLMs to generate further candidate task prompts.

### Generate Nodes Process 700

In some embodiments, the modification server 506 may further be configured to generate the plurality of nodes 612 and the plurality of edges 614 of the progress display 610 (shown in FIG. 5). As described above, the progress display 610 including the nodes 612 and the edges 614 may enable users associated with the user devices 504 to select a previous task prompt and a previous at least one candidate output generated based on the previous task prompt for re-evaluation or re-engineering thereof.

In the embodiment shown, the generate nodes process 700 is performed by the prompt modification processor 520 executing processor, machine and/or computer readable instructions stored in the program memory 524. In other embodiments, the generate nodes process 700 may comprise processor, machine and/or computer readable instructions alternatively stored on other non-transitory computer readable storage medium such as a CD-ROM, a floppy disk, a hard drive, a DVD, a Blu-ray disk or another component associated with the modification server 506; in yet other embodiments, the generate nodes process 700 and/or parts thereof could alternatively be executed by a device other than the prompt modification processor 520, including for example, by the language model servers 502 and/or the user devices 504. Further, although the generate nodes process 700 in accordance with one embodiment is described below, other methods of implementing the generate nodes process 700 may alternatively be used.

The generate nodes process 700 may include codes directing the prompt modification processor 520 to retrieve nodes entries in the node datastore 651 and edges entries in the edge datastore 653 which are associated with each other. For example, the prompt modification processor 520 may retrieve node entries from the node datastore 651 and edge entries from the edge datastore 653 which share a common task identifier to retrieve nodes 612 and edges 614 which are associated with a specific processing task. Alternatively, the generate nodes process 700 may also include codes directing the prompt modification processor 520 to node entries from the node datastore 651 and edge entries from the edge datastore 653 which share a common user identify to retrieve nodes 612 and edges 614 which are associated with a particular user. Additionally or alternatively, the prompt modification processor 520 may retrieve node entries from the node datastore 651 and edge entries from the edge datastore 653 which share a common model identifier to retrieve nodes 612 and edges 614 which are associated with a specific language model.

The generate nodes process 700 may also include codes directing the prompt modification processor 520 to display the retrieved nodes 612 and edges 614 in the progress display 610 (shown in FIG. 5), based on which ones of the edges 614 connect which ones of the nodes 612. As described above, each of the nodes 612 may be associated with a candidate task prompt and at least one candidate output generated by a language model using the associated candidate task prompt and each of the edges 614 may be associated with a modification prompt comprising user input directed to the candidate task prompt and/or the at least one candidate output and a subsequent candidate task prompt generated the language model using the associated modification prompt. Nodes 612 may be connected by an edge 614 when one of the nodes 612 is associated with a first task prompt (e.g., a current candidate task prompt) and at least one first candidate output and another one of the node 612 is associated with a second task prompt (e.g., a subsequent candidate task prompt) generated by a language model based on user input directed to the first task prompt and/or the at least one first candidate output.

The generate nodes process 700 may also include codes directing the modification processor 520 to, in response to user selection of a particular node of the nodes 612, automatically populate the candidate template 560 (shown in FIG. 5) such that the task prompt associated with the selected node 612 is automatically displayed in the task prompt region 564 and the at least one candidate output associated with the selected node 612 is automatically displayed in the candidate output region 566.

### Alternative Method 750

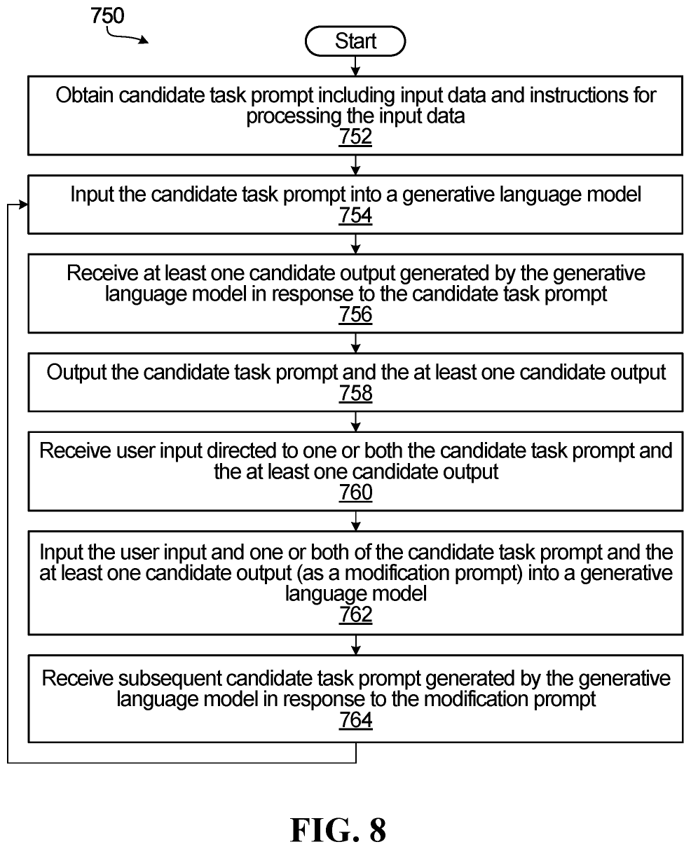

Referring now to FIGS. 3 and 8, an alternative computer-implemented method for generating candidate task prompts using a generative model such as a LLM is generally shown at 750. In the embodiment shown, the method 750 is performed by the prompt modification processor 520 executing processor, machine and/or computer readable instructions stored in the program memory 524. In other embodiments, the method 750 may comprise processor, machine and/or computer readable instructions alternatively stored on other non-transitory computer readable storage medium such as a CD-ROM, a floppy disk, a hard drive, a DVD, a Blu-ray disk or another component associated with the prompt modification server 506; in yet other embodiments, the method 750 and/or parts thereof could alternatively be executed by a device other than the prompt modification processor 520, including for example, by the user devices 504 and/or by the language model servers 502. Further, although the method 750 in accordance with one embodiment is described with reference to the flowchart illustrated in FIG. 8, other methods of implementing the method 750 may alternatively be used. For example, the order of execution of the blocks may be altered, and/or some of the blocks described may be altered, eliminated, or combined.

At block 752, the prompt modification server 506 may obtain a candidate task prompt including input data and candidate instructions for processing the input data. For example, similar to block 652 of the modify task prompt process 650, block 752 may also direct the prompt modification server 506 to (a) to display the candidate template 560 (shown in FIG. 5) via a display of a user device 504 and (b) wait to receive a current candidate task prompt in the task prompt region 564 (e.g., candidate instructions in the instructions subregion 580 and input data in the input data subregion 582). The current candidate task prompt comprising candidate instructions and input data may be inputted by a user associated with the user device 504 or may be partially generated by a generative language model in response to a modification prompt (e.g., after block 676 of the modify task prompt process 650).

At block 754, the prompt modification server 506 may input at least the current candidate task prompt into a generative language model. For example, similar to block 656 of the modify task prompt process 650, block 754 may also direct the prompt modification server 506 to transmit the current candidate task prompt received at block 752 to a language model server 502 (shown in FIGS. 2 and 3) hosting/storing a LLM selected to receive task prompts using the language model selector 562 of the candidate template 560.

At block 756, the prompt modification server 506 may receive, from the generative language model and responsive to the input of at least the current candidate task prompt, at least one candidate output generated by the generative language model. For example, similar to block 658 of the modify task prompt process 650, block 756 may also direct the prompt modification server 506 to wait to receive the at least one candidate output transmitted from the language model server 502 hosting/storing the LLM selected to receive task prompts using the language model selector 562 of the candidate template 560.

At block 758, the prompt modification server 506 may output the current candidate task prompt and the at least one candidate output. For example, similar to block 660 of the modify task prompt process 650, block 758 may also direct the prompt modification server 506 to (a) display the current candidate task prompt in the task prompt region 564 and (b) display the at least one candidate output received at block 756 in candidate output region 566 (e.g., specifically in the output display subregion 590). In other embodiments, block 758 may direct the prompt modification server 506 to otherwise transmit or output the current candidate task prompt and the at least one candidate output to the user device 504.

At block 760, the prompt modification server 506 may receive user input directed to one or both of the candidate task prompt and the at least one candidate output. For example, similar to block 662 of the modify task prompt process 650, block 760 may also direct the prompt modification server 506 to wait to receive user input from the user associated with the user device 504 in the candidate output region 566 of the candidate template 560. In some embodiments, the user input comprises at least one of comments inputted in the user comment subregions 592, scores inputted in the user score subregions 594 and flag selections inputted in the user flag subregions 596 as described above.

At block 762, the prompt modification server 506 may input at least the user input and one or both of the current candidate task prompt and the at least one candidate output into the generative language model as a modification prompt. For example, similar to block 668 of the modify task prompt process 650, block 762 may also direct the prompt modification server 506 to transmit the modification prompt comprising the user input and one or both of the current candidate task prompt and the at least one candidate output to a language model server 502 hosting/storing a LLM selected to receive modification prompts using the language model selector 562 of the candidate template 560. In some embodiments, the LLM selected to receive the modification prompts may be the same as the LLM selected to receive the task prompts at block 754; however, in other embodiments, the LLM selected to receive the modification prompts may be different from the LLM selected to receive the task prompts. In embodiments where the user input comprises at least one of the comments, scores and flag selections described above, block 762 may direct the prompt modification server 506 to input the at least one of the comments, the scores and the flag selections into the generative language model.

At block 764, the prompt modification server 506 may receive, from the generative language model and responsive to the input of the modification prompt (e.g., comprising the user input and one or both of the candidate task prompt and the at least one candidate output) a subsequent candidate task prompt generated by generative language model. For example, similar to block 670 of the modify task prompt process 650, block 764 may also direct the prompt modification server 506 to wait to receive the subsequent candidate task prompt transmitted from the language model server 502 hosting/storing the LLM selected to receive modification prompts. Additionally, in some embodiments, similar to block 672 of the modify task prompt process 650, block 764 may also direct the prompt modification server 506 to display the subsequent candidate task prompt in the modify prompt region 568 of the candidate template 560 (e.g., specifically the prompt display subregion 602).

The method 750 may further direct the prompt modification server 506 to input at least the subsequent candidate task prompt back into the generative language model (e.g., repeat block 754 with the subsequent candidate task prompt as the candidate task prompt) and to receive, from the generative language model and responsive to input of the subsequent candidate task prompt, at least one subsequent candidate output generated by the generative language model (e.g., repeat block 756 with the subsequent candidate task prompt as the candidate task prompt).

The method 750 may further direct the prompt modification server 506 to receive subsequent user input directed to one or both of the subsequent candidate task prompt and the at least one subsequent candidate output (e.g., repeat block 760 with the at least one subsequent candidate output as the at least one candidate output), input the subsequent user input into the generative language model (e.g. repeat block 762 with the subsequent user input as the user input), and receive, from the generative language model and responsive to input of at least the subsequent user input, a further subsequent candidate prompt generated by the generative language model (e.g., repeat block 764 with the further subsequent candidate task prompt as the subsequent candidate task prompt). The further subsequent candidate task prompt includes further modified candidate instructions which are different from the modified candidate instructions in the subsequent candidate task prompt. The further modified candidate instructions may also be different from the candidate instructions in the initial candidate task prompt.

The method 750 may further direct the prompt modification server 506 to revert back to inputting the initial candidate task prompt into the generative language model yielding the at least one candidate output (e.g., repeat block 754) responsive to receiving the at least one subsequent candidate output. This may be useful in situations where the at least one subsequent candidate output (generated using the subsequent candidate task prompt) is of a lower quality than the at least one candidate output (generated using the initial candidate task prompt).

The method 750 may further direct the prompt modification server 506 to iteratively input successive candidate task prompts generated by the generative language model back into the generative language model to generate corresponding successive at least one candidate outputs. The method 750 may also direct the prompt modification server 506 to iteratively receive user input directed to one or more of the successive candidate task prompts and the corresponding successive at least one candidate outputs and to iteratively input the user input together with one or more of the successive candidate prompts and the corresponding successive at least one candidate outputs back into the generative language model to generate further candidate prompts.

### Conclusion

While specific embodiments have been described and illustrated, such embodiments should be considered illustrative of the subject matter described herein and not as limiting the claims as construed in accordance with the relevant jurisprudence.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g., read-only-memory (ROM) or a disk), or memory that is volatile (e.g., random access memory (RAM)). The memory may be distributed, e.g., a same memory may be distributed over one or more servers or locations.

1. A computer-implemented method comprising:
obtaining a candidate prompt including input data and candidate instructions for processing the input data;
inputting at least the candidate prompt into a generative language model;
receiving, from the generative language model and responsive to input of at least the candidate prompt, at least one candidate output generated by the generative language model;
outputting the candidate prompt and the at least one candidate output;
receiving user input directed to one or both of the candidate prompt and the at least one candidate output;
inputting at least the user input and one or both of the candidate prompt and the at least one candidate output into the generative language model; and
receiving, from the generative language model and responsive to input of at least the user input and one or both of the candidate prompt and the at least one candidate output, a subsequent candidate prompt generated by the generative language model, wherein the subsequent candidate prompt includes modified candidate instructions for processing the input data which are different from the candidate instructions.

2. The computer-implemented method of claim 1, wherein the user input comprises a score of one or both of the candidate prompt and the at least one candidate output, and wherein inputting the user input into the generative language model comprises:
inputting the score into the generative language model.

3. The computer-implemented method of claim 1, wherein the user input further comprises at least one of a comment associated with one or both of the candidate prompt and the at least one candidate output; or a flag associated with one or both of the candidate prompt and the at least one candidate output, and wherein inputting the user input into the generative language model comprises:
inputting at least one of the comment or the flag into the generative language model.

4. The computer-implemented method of claim 1, further comprising:
inputting at least the subsequent candidate prompt back into the generative language model; and
receiving, from the generative language model and responsive to input of the subsequent candidate prompt, at least one subsequent candidate output generated by the generative language model.

5. The computer-implemented method of claim 4, further comprising:
receiving subsequent user input directed to one or both of the subsequent candidate prompt and the at least one subsequent candidate output;
inputting the subsequent user input and one or both of the subsequent candidate prompt and the at least one subsequent candidate output into the generative language model; and
receiving, from the generative language model and responsive to input of at least the subsequent user input and one or both of the subsequent candidate prompt and the at least one subsequent candidate output, a further subsequent candidate prompt generated by the generative language model, wherein the further subsequent candidate prompt includes further modified candidate instructions for processing the input data which is different from the modified candidate instructions.

6. The computer-implemented method of claim 4, further comprising:
reverting back to inputting the candidate prompt into the generative language model yielding the at least one candidate output responsive to receiving the at least one subsequent candidate output.

7. The computer-implemented method of claim 1, further comprising:
iteratively inputting successive candidate prompts generated by the generative language model back into the generative language model yielding corresponding successive at least one candidate outputs.

8. The computer-implemented method of claim 7, further comprising:
iteratively receiving user input directed to one or more of the successive candidate prompts and the corresponding successive at least one candidate outputs; and
iteratively inputting the user input and one or more of the successive candidate prompts and the corresponding successive at least one candidate outputs back into the generative language model to generate further candidate prompts.

9. The computer-implemented method of claim 1, further comprising a candidate template for iteratively receiving different candidate prompts including at least one of different candidate instructions or different input data, and wherein obtaining the candidate prompt, inputting at least the candidate prompt into the generative language model and receiving the at least one candidate output comprises:
iteratively inputting the candidate template including the different candidate prompts into the generative language model; and
iteratively receiving, from the generative language model and responsive to the inputting of the candidate template, corresponding different at least one candidate outputs generated by the generative language model.

10. The computer-implemented method of claim 9, wherein the candidate template includes:
a prompt region for inputting the different candidate prompts, the prompt region including an instructions subregion for inputting the different candidate instructions and an input data subregion for inputting the different input data; and
an output region for displaying the corresponding different at least one candidate outputs.

11. The computer-implemented method of claim 1, wherein outputting the candidate prompt and the at least one candidate output comprises outputting for display, on a display of a user device, the candidate prompt and the at least one candidate output.

12. The computer-implemented method of claim 1, further comprising:
storing a plurality of nodes, each node comprising a prompt and at least one output generated by the generative language model based on the prompt, wherein a first node and a second node of the plurality of nodes are connected by an edge when the first node includes a first prompt and at least one first output and the second node includes a second prompt generated by the generative language model utilizing user input directed to one or both of the first prompt and the at least one first output.

13. The computer-implemented method of claim 12, further comprising outputting for display, on a display of a user device, a progress region including the plurality of nodes and edges between nodes of the plurality of nodes.

14. The computer-implemented method of claim 13, further comprising:
automatically outputting a particular prompt associated with a particular node and at least one particular output associated with the particular node in response to user selection of the particular node.

15. The computer-implemented method of claim 1 wherein the at least one candidate output comprises a plurality of candidate outputs and receiving the user input comprises receiving user input directed to different candidate outputs of the plurality of candidate outputs.

16. A system comprising:
at least one processor; and
a memory storing processor-executable instructions that, when executed, cause the at least one processor to:
input at least a candidate prompt including input data and candidate instructions for processing the input data into a generative language model;
receive, from the generative language model and responsive to the input of the candidate prompt, at least one candidate output generated by the generative language model;
output the candidate prompt and the at least one candidate output;
receive user input directed to one or both of the candidate prompt and the at least one candidate output;
input at least the user input and one or both of the candidate prompt and the at least one candidate output into the generative language model; and
receive, from the generative language model and responsive to the input of at least the user input and one or both of the candidate prompt and the at least one candidate output, a subsequent candidate prompt generated by the generative language model, wherein the subsequent candidate prompt includes modified candidate instructions for processing the input data which are different from the candidate instructions.

17. The system of claim 16, wherein the processor-executable instructions further comprise processor-executable instructions which cause the at least one processor to:
iteratively input successive candidate prompts generated by the generative language model back into the generative language model yielding corresponding successive at least one candidate outputs.

18. The system of claim 17, wherein the processor-executable instructions further comprise processor-executable instructions which cause the at least one processor to:
iteratively receive user input directed to one or more of the successive candidate prompts and the corresponding successive at least one candidate outputs; and
iteratively input the user input and one or more of the successive candidate prompts and the corresponding successive at least one candidate outputs back into the generative language model to generate further candidate prompts.

19. The system of claim 16, wherein the processor-executable instructions further comprise processor-executable instructions which cause the at least one processor store a plurality of nodes, each node comprising a prompt and at least one output generated by the generative language model based on the prompt, wherein a first node and a second node of the plurality of nodes are connected by an edge when the first node includes a first prompt and at least one first output and the second node includes a second prompt generated by the generative language model utilizing user input directed to one or both of the first prompt and the at least one first output.

20. A non-transitory computer-readable storage medium having stored thereon processor-executable instruction that, when executed, cause at least one processor to:
obtain a candidate prompt including input data and candidate instructions for processing the input data;
input at least the candidate prompt into a generative language model;
receive, from the generative language model and responsive to the input of at least the candidate prompt, at least one candidate output generated by the generative language model;
output the candidate prompt and the at least one candidate output;
receive user input directed to one or both of the candidate prompt and the at least one candidate output;
input at least the user input and one or both of the candidate prompt and the at least one candidate output into the generative language model; and
receive, from the generative language model and responsive to the input of at least the user input and one or both of the candidate prompt and the at least one candidate output, a subsequent candidate prompt generated by the generative language model, wherein the subsequent candidate prompt includes modified candidate instructions for processing the input data which are different from the candidate instructions.
